(19) United States
(12) Patent Application Publication
(10) Pub. No.: US 2015/0183664 A1
(43) Pub. Date: Jul. 2, 2015

(54) Automatic Rubber Belt Skimmer for Restaurant Wastewater FOG Interceptor

(71) Applicant: Jeremy Pan, Fort Lee, NJ (US)

(72) Inventor: Jeremy Pan, Fort Lee, NJ (US)

(73) Assignee: Jeremy Pan, Fort Lee, NJ (US)

(21) Appl. No.: 14/144,314

(22) Filed: Dec. 30, 2013

(51) Int. Cl. C02F 1/40

(52) U.S. Cl. CPC C02F 1/40

(57) ABSTRACT

In the current U.S. market, there are a number of different FOG interceptors used for restaurant wastewater treatment. The present invention relates to a simplified three chamber of FOG interceptor which has a removable flat rubber belt skimmer. The rubber used in the invention is common market oil resistant rubber and can stand for a media temperature. Newly designed rubber pulley has a special structure which allows the grease, which adhered on both sides of the rubber, to be carried to scraper and be discharged. Degreasing efficiency of the double-sided scraper skimmer can be up to 95%. The invention also relates to methods and devices for filtering solid waste and separating oils and greases from wastewater. The invention is a simplified three chambers container with a removable solids strainer in the first chamber. The filtered wastewater then flows into the second chamber, in which oils and/or greases will separate with wastewater by gravity. A removable rubber belt skimmer is mounted in the second chamber. The programmable skimmer runs automatically for FOG removal and collection. Clarified effluent is collected in the third chamber and discharged into the sewer system through the outlet port.

### FIELD OF THE INVENTION

The present invention relates to remove grease and solid waste from oily wastewater in food industry, especially for restaurant wastewater treatment.

### BACKGROUND OF THE INVENTION

Restaurant is one of the most important businesses which related with people's daily life.

Restaurants wastewater contains large amounts of food debris, as well as animal fats and vegetable oil, becoming a major threat to environmental pollution. After discharging into the sewer system, grease will gradually accumulate on the pipe inner wall and eventually will block the pipe. Pipe blockage may lead to the costly cleaning and maintenance. If not clean up frequently, sewage may overflow from the cellar bowl of customers to the restaurant kitchen and dining areas, cause serious adverse effects to the restaurant. Thus, the U.S. Environmental Protection Agency requires that all restaurants install grease traps. Currently, there are many non-automatic grease traps, which require manually discharging grease, in various restaurants.

Due to many problems may associated with non-automatic grease traps, some states require automatically degrease devices must be installed.

U.S. Pat. Nos. 5,030,357, 4,268,396 and 5,133,881 disclosed that due to the higher oil affinity of polyethylene, degrease in a skimmer is completed with a polyethylene rotating wheel and polyethylene scraper. The significant disadvantages in the above prior arts are complex structure, difficult of manufacture, and high cost. Therefore, it is necessary to continue to seek a cost-efficient oil removal and collection system of the FOG interceptor device. The present invention satisfies this need, with relative economic advantage.

### BRIEF SUMMARY OF THE INVENTION

The present invention is a gravity flow based automatic grease trap. It may be used as initial wastewater treatment at restaurants. The apparatus has the ability to remove solid waste. The apparatus of the present invention is a container, which is divided into multiple cells by baffles.

In the first compartment, there is a solid waste filter collector. A grease collecting and removing device is located in the second compartment. The third cell is used to collect elucidated wastewater.

The invention also contemplates a method for a novel grease trap to remove and collect grease.

Comparing to prior arts, the advantages of the present invention are low-cost, easy of maintenance, and higher degreasing efficiency.

Another advantage of this device is to save the cost of further sewage cleaning.

The invention is described in details in the following diagrams.

### BRIEF DESCRIPTION OF THE DRAWINGS

FIG. 1 is a front view of interceptor.

FIG. 2 is a plan view of interceptor.

### DETAILED DESCRIPTION OF THE INVENTION

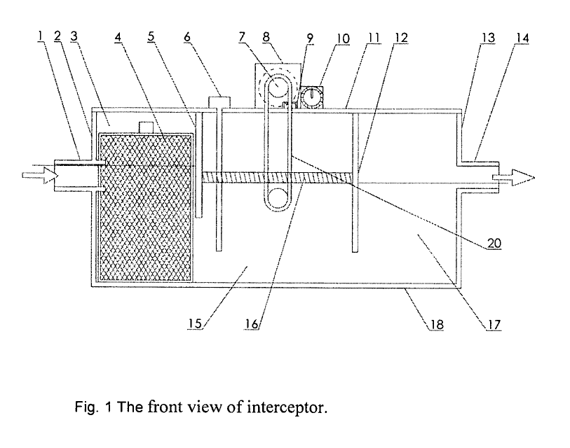

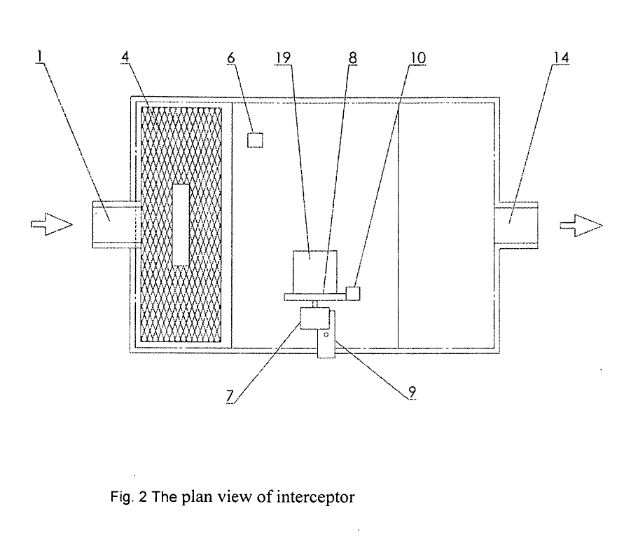

Referring to FIG. 1 and FIG. 2, the drawings show a typical case, the present invention is a three chambers container (18) divided by the first restriction baffle (5) and the second restriction baffle (12). The arrows in FIG. 1 and FIG. 2 show the wastewater flow direction. The container (18) is made of stainless steel. The first restriction baffle (5) and the second restriction baffle (12) were L shape and welded to the container (18), the top end of both restriction baffles touch the container cover and their lower end do not extend to the container bottom, resulting in wastewater flowing beneath the restriction baffles.

The wastewater, containing the solid waste from the sink, floor drain, steamer or dishwasher, is discharged via the inlet (1), which is installed on the front end wall (2) of the container, into the first chamber (3). The wastewater, containing solid waste, is forced to flow through a solid waste filter (4) and enter into the second chamber (15) through the gap of 1^{st} baffle and the bottom of the container. Solid waste filter (4) which mounted in the first chamber (3) is a removable porous mesh basket made of stainless steel. Its structure can ensure solid waste collection and treatment effectively.

The first restriction baffle (5) is a baffle which between the first chamber (3) and the second chamber (15). It is placed to form a wastewater pond in the first chamber (3). This wastewater pond allows solid waste material precipitated in the filter (4). Thus the wastewater which removed solid waste and containing oil flows into the second chamber (15) beneath the baffle (5).

The second chamber (15) is between the first restriction baffle (5) and the second restriction baffle (12) and acts as storage, grease water separation, and grease collection space for the solid free wastewater. The gap between 1^{st} baffle and container bottom is greater than that between 2^{nd} baffle and container bottom, which makes the filtered wastewater slowly move into 2^{nd} chamber and allow grease to have enough time to separate with wastewater in the 2^{nd} chamber by gravity.

A heater (6), is installed inside the 2^{nd} chamber to heat the liquid and to accelerate fat-water separation. Both the restriction baffles (5, 12) do not extend to the base of the interceptor (18), so that the sewage which removed grease into the third chamber (17) beneath the second restriction baffle (12), separated oil (16) left in the second chamber (15).

There is a rubber belt skimmer (7) in the second chamber (15) to remove grease. Its belt extends below the first weir baffle (5), and can run automatically according to the preset period. This rubber belt skimmer (7) consist of one fixed tail pulley, one run pulley, one flat rubber belt (20) and one motor (19). In the present invention the special structure of the belt pulley allows the grease which adhered on both sides of the rubber get through, go to the other side for double-sided scrapping, then into the drain chute (9), and transfer into the grease collection container.

There is a timer (10) between the motor (19) and the power supply, to set a predetermined run period to skim the grease (16).

The third chamber(17) is between the second restriction baffle (12) and container end wall (13).

There is a clean wastewater pond in the third chamber (17). Outlet port (14) located on the end wall (13) of interceptor (18), the height slightly below the inlet port (1), so that discharge treated wastewater by gravity. Outlet port (14) connected to a conventional sewerage system (not shown in the drawings), clean treated water transfer to a public or private wastewater treatment facilities for final processing. Waste water in one direction from a higher inlet port (1) into the first chamber (3), remove the solid waste, in a second chamber (15) separating fat, and via the third chamber (17), get through from a relatively low water outlet (14).

The size of inlet port (1) and outlet port (14) are determined in accordance the desired flow rate, when necessary, an orifice should be placed in the inlet port (1) for flow control to prevent shock loading.

What is claimed is:

1. The present invention is involved with an improved and simplified FOG interceptor which consists of only three chambers. The first chamber has an inlet for collecting wastewater and is used to remove solid waste from wastewater. The second chamber is located between the downstream of the first chamber and the upstream of the third chamber. In the second chamber, oil and grease is separated from the sewage by the gravity. The third chamber is used to collect the clarified wastewater which solids and FOG had been removed.

2. The interceptor of claim 1 consists of a flat rubber belt skimmer in the second chamber.

3. The interceptor of claim 1 also includes a removable cover. The skimmer and the entire control device are mounted on the cover.

4. The FOG interceptor is a container that has an inlet for receiving wastewater. The FOG interceptor has an outlet to discharge wastewater into sewage system. The position of the interceptor inlet is higher than the position of its outlet, so that the wastewater can flow by gravity from the inlet to the outlet. The first chamber is located downstream of the inlet and it contains a moveable solid waste collector to filter off solid waste. The first restriction baffle is used to divide the first chamber and the second chamber. The third chamber is located downstream of the second chamber and is used to collect clarified sewage. The second restriction baffle is located between the second and the third chamber. Both baffles do not extend to the bottom floor of the container, which forces effluents between chambers beneath the baffle. The third chamber is located between the downstream of second chamber and upstream of outlet. The effluent from the third chamber is directly charged into the sewer system. The incoming untreated wastewater first flows through the first chamber to remove solids waste. Then the clarified wastewater flows to the second chamber beneath the first restriction baffle. After oil and grease float to the surface, wastewater will flow beneath the second restriction baffle and enter into the third chamber.

5. In the claim 2, the flat rubber belt skimmer is a programmable auto-run flat rubber belt skimmer, wherein the rubber belt is oil and heat resistant with good affinity to the FOG. Specially designed belt pulley makes double-sided scrapping practicable, which greatly improves the efficiency of the skimmer. A programmable timer is connected to the skimmers and the skimmer can operate automatically when needed.

6. In the claim 1, the second chamber of the interceptor contains a heating element to accelerate separation of grease from the wastewater effluents.

7. The interceptor of claim 1 also contains an inlet flow restrictor, which is located at the upstream of the interceptor to ensure smooth operation.

8. In the interceptor of claim 4, all the skimmers, heaters, timers and other electrical control devices are installed in the removable cover. By exchanging the above cover with a general cover, The FOG interceptor can be converted into a general FOG interceptor.
